(19) United States
(12) Patent Application Publication
(10) Pub. No.: US 2002/0131046 A1
(43) Pub. Date: Sep. 19, 2002

(54) Optical soil sensor for mobilized measurement of in-situ soil characteristics

(75) Inventors: Colin D. Christy, Salina, KS (US); Paul E. Drummond, Minneapolis, KS (US)

Correspondence Address: Michael J. Gross, SHOOK, HARDY & BACON L.L.P., 1200 Main Street, Kansas City, MO, 64105-2118, US

(73) Assignee: Kejr, Inc.

(21) Appl. No.: 09/804,720

(22) Filed: Mar. 13, 2001

(51) Int. Cl. G01N 21/55

(52) U.S. Cl. 356/445

(57) ABSTRACT

An optical soil sensor for mobilized measurements of in-situ soil characteristics has a shank assembly, which creates a furrow in which a soil sample is exposed, and a window plate assembly including a window through which emitted and reflected light pass. The sensor window, formed of a hard and durable material, is positioned in intimate contact with the soil sample as the sensor moves across the ground or field and is continually scoured by the soil to greatly reduce or eliminate window buildup and contamination. The intimate contact between the window and soil also eliminates the sample distance or air gap through which light must pass, thereby reducing measurement distortion and error. The soil sensor provides a structural platform compatible with a wide variety of light sources, light detectors, signal conditioners, and other devices.

### STATEMENT REGARDING FEDERALLY SPONSORED RESEARCH OR DEVELOPMENT

Not Applicable.

### CROSS-REFERENCE TO RELATED APPLICATIONS

Not Applicable.

### BACKGROUND OF THE INVENTION

This invention relates generally to soil sensors, and more particularly to an optical soil sensor for mobilized measurements of in-situ soil characteristics. Various optical methods and devices are available for the measurement of soil constituents such as organic matter. Generally, these methods involve illuminating the soil with an artificial light source and then measuring the light reflected from the soil or the light resulting from the fluorescence of soil constituents.

U.S. Pat. No. 5,044,756 to Gaultney et al. and U.S. Pat. No. 5,038,040 to Funk et al. disclose in-situ soil testing devices that are used while the device moves across ground such as an agricultural field. However, both Gaultney et al. and Funk et al. disclose devices requiring a sample distance or gap between the sensor window and the soil being sampled. These devices have several important drawbacks. First, neither the Gaultney et al. or Funk et al. device provide a method for keeping clean the window through which light travels in and out. Given the harsh operating environment in which these soil sensors operate, materials such as dirt, dust, mud, debris, and moisture will invariably adhere to and contaminate the window, impede the passage of light through the window, and detrimentally affect the performance of the sensor.

Second, dust and other airborne material in the sample distance or gap through which the emitted and reflected light must travel will scatter and interact with the light and cause measurement distortion or error. Consequently, it is desirable to minimize or completely eliminate any sample distance or air gap between the window and soil sample in order to improve the quality and integrity of the measurements.

U.S. Pat. No. 5,739,536 to Bucholtz et al. discloses a probe, or “penetrometer,” for penetrating the soil to obtain information on chemicals present at various depths of the soil. While the window of the Bucholtz et al. device is in intimate contact with the soil being sampled, the Bucholtz et al. reference does not allow for mobilized measurement of soil characteristics as the soil sensor moves horizontally across the ground or field. Similarly, U.S. Pat. No. 5,887,491 to Monson et al. discloses a soil probe which is inserted into the soil for determining various soil characteristics, but does not allow for mobilized measurements.

There is a therefore a need for an optical soil sensor device with an inherently self-cleaning window that provides for mobilized measurement of in-situ soil characteristics as the device moves across a field or other ground, and which maintains measurement quality and integrity by eliminating the sample distance or gap between the window and the soil being sampled.

### SUMMARY OF THE INVENTION

Accordingly, it is an object of the present invention to provide an optical soil sensor for measurement of in-situ soil characteristics as the sensor moves across ground such as an agricultural field.

It is a further object of the present invention to eliminate the sample distance or gap between the window of the device and the soil being sampled and to provide for intimate contact between the window and the soil.

Another object of the present invention is to provide an inherently self-cleaning, self-scouring window that eliminates or greatly reduces buildup on and contamination of the window in a harsh operating environment such as an agricultural field.

Another object of the present invention is to provide a substantially flat and uniform soil surface on which the soil sensor and window operates.

Another object of the present invention to provide a structural platform for a variety of light sources, light detectors, signal conditioners, and other electrical and electro-mechanical devices.

Accordingly, the present invention provides for an optical soil sensor for mobilized measurements of in-situ soil characteristics. The sensor has a shank assembly, which creates a furrow in which a soil sample is exposed, and a window plate assembly including a window through which emitted and reflected light pass. The sensor window, formed of a hard and durable material, is positioned in intimate contact with the soil sample as the sensor moves across the ground or field and is therefore continually cleaned and scoured by the soil to greatly reduce or eliminate window buildup and contamination. The intimate contact between the window and the soil also eliminates a sample distance or gap through which light must pass, thereby reducing measurement distortion or error. Finally, the soil sensor of the present invention provides a structural platform compatible with a wide variety of light sources, light detectors, signal conditioners, and other devices.

### BRIEF DESCRIPTION OF THE DRAWINGS

In the accompanying drawings, which form a part of the specification and are to be read in conjunction therewith, and in which like reference numerals are used to indicate like parts in the various views:

FIG. 1 is an elevation view showing the soil sensor, coulter, and gauge wheels coupled with and traveling behind a tractor.

FIG. 2 is a fragmentary side elevation view of the soil sensor with portions broken away showing the shank assembly coupled with the window plate assembly and the bottom surfaces of the window plate and shank tip in intimate contact with the soil sample.

FIG. 3 is a detailed fragmentary cutaway view showing generally the light source, light detector, mounting block, window plate, and window.

FIG. 4 is an exploded fragmentary perspective view showing the shank assembly and the window plate assembly.

FIG. 5 is a fragmentary perspective view showing the window plate assembly, shown in phantom lines, coupled with the shank assembly.

### DETAILED DESCRIPTION OF THE PREFERRED EMBODIMENTS

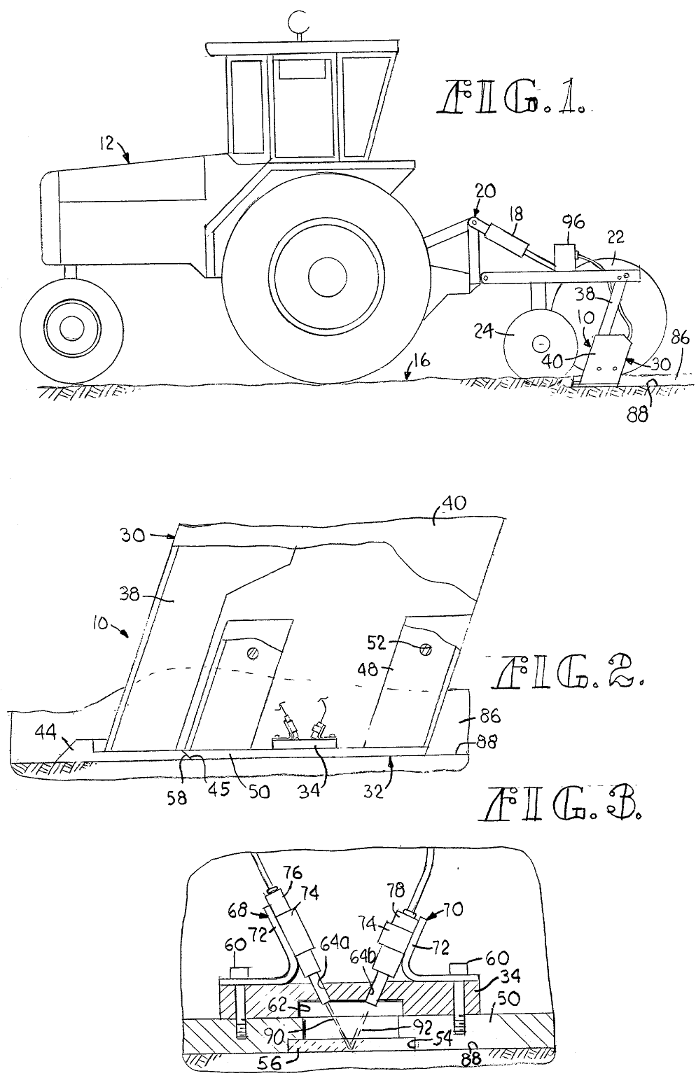

Referring to the drawings in greater detail, and initially to FIG. 1, an optical soil sensor for mobilized measurements of in-situ soil characteristics is designated generally by the numeral 10. The soil sensor 10 is coupled with a vehicle 12 such as a tractor and travels behind vehicle 12 as the vehicle 12 moves across the surface 16 of ground such as a farm field. The position of soil sensor 10 relative to the surface 16 of the ground is adjustable using a hydraulic piston 18 and a mechanical linkage 20, or by other means well known to those skilled in the art. Gauge wheels 22 are coupled with vehicle 12 and travel on the surface 16 of the ground and behind the vehicle 12. The gauge wheels 22 serve to support, and provide a height reference for, soil sensor 10. For the sake of clarity, only one gauge wheel 22 is shown in FIG. 1, but it will be understood that at least one wheel 22 is positioned on each side of soil sensor 10 to provide adequate support for sensor 10. As shown in FIG. 1, a coulter 24 may be coupled with vehicle 12 ahead and in the path of soil sensor 10. Coulter 24 makes a vertical cut in the surface 16 of the ground and, in doing so, cuts stalks and other debris lying in the path of soil sensor 10 that might otherwise wrap around, damage, or affect the performance of sensor 10.

As best seen in FIGS. 4 and 5, soil sensor 10 includes a shank assembly 30, a window plate assembly 32, and a mounting block 34 that, when coupled with each other, provide a structural platform 36 that carries the light source, light detector, cables, and other electrical and electro-mechanical components of sensor 10. As best seen in FIGS. 1 and 4, shank assembly 30 includes a shank extension 38 coupled at its upper end with vehicle 12 through mechanical linkage 20 and coupled at its lower end with shank plate 40. As shown in FIG. 4, shank plate 40 is a single structural member formed or bent into a generally “U” or “V” shape, with a leading edge 42 and an interior edge 43 at the closed end of plate 40. Shank extension 38 is coupled with shank plate 40 by welding the lower end of shank extension 38 to the interior edge 43 of plate 40. It will be understood to one skilled in the art that shank extension 38 may be rigidly coupled with shank plate 40 by bolts, rivets, or other suitable mechanical fastening means.

As best seen in FIG. 4, A shank tip 44 is coupled with the shank plate 40 adjacent the lower edge of plate 40 and at the leading edge 42. Shank tip 44 has a first beveled edge 45 and is preferably coupled with shank plate 40 by spot welding, bolts, rivets, or other means well known to those skilled in the art. Shank tip 44 will wear during use and, therefore, the method of coupling shank tip 44 with shank plate 40 should preferably allow shank tip 44 to be removed from plate 40 and replaced relatively easily. Shank plate 40 has mounting holes 46 formed therein for use in coupling shank plate 40 with window plate assembly 32, as described below.

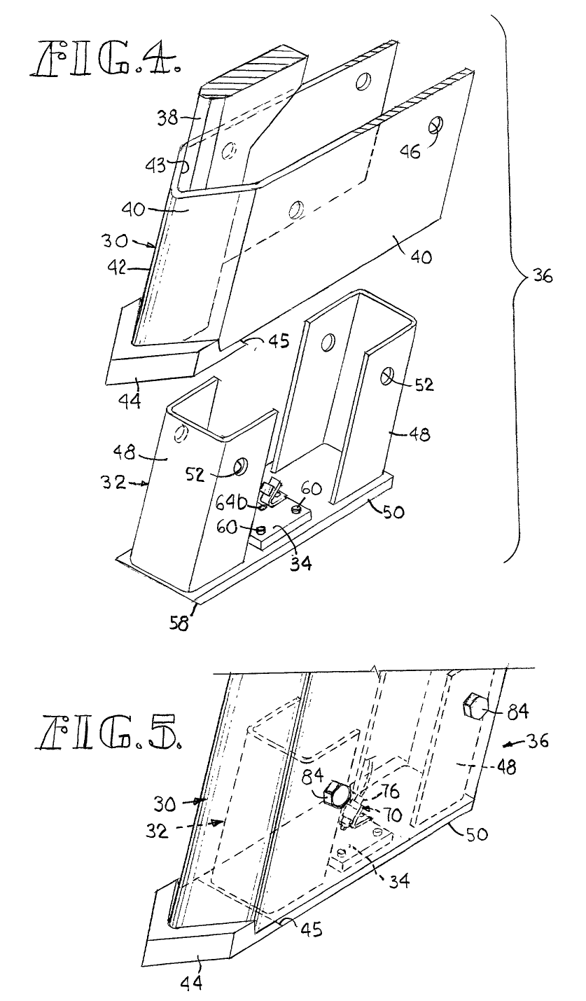

Window plate assembly 32 generally includes connector brackets 48 and a window plate 50, as best seen in FIG. 4. Brackets 48 are generally “U” or “C” shaped channel members rigidly coupled at one end with window plate 50 by welding or other suitable mechanical means. Brackets 48 extend obliquely from plate 50 at an angle corresponding to the contours of shank plate 40, as depicted in FIGS. 2 and 4. Brackets 48 have bolt holes 52 formed therein for use in coupling brackets 48 with shank plate 40, as described below. As best seen in FIG. 3, window plate 50 has an aperture 54 therein. A window 56 is mounted within aperture 54 and is coupled with window plate 50 by adhesive, shrink fit, beveled edges, or other suitable mechanical fastening means. It will be understood that, due to the abrasive nature of soil, window 56 will wear during use and should therefore be coupled with plate 50 by means that allow a worn window 56 to be removed from plate 50 and a new window 56 to be replaced with relative ease. Window 56 is preferably formed of a synthetic sapphire material. It will be understood, however, that window 56 may be formed of any sufficiently transparent and wear-resistant material. Window plate 50 has a second beveled edge 58, as best seen in FIG. 4. Edge 58 is beveled at an angle determined by the angle of the first beveled edge 45 of shank tip 44, such that first beveled edge 45 is in intimate and continuous contact with second beveled edge 58 when shank assembly 30 is coupled with window plate assembly 32, as described below.

Referring now to FIGS. 3 and 4, mounting block 34 is coupled with and above window plate 50 by bolts 60 or other suitable mechanical fastening means. As best seen in FIG. 3, a recessed cavity 62 is formed in the bottom surface of block 34, and first and second angled passages 64a and 64b extend from the upper surface 65 of block 34 to the recessed cavity 62. A light source mounting assembly 68 and a light detector mounting assembly 70 are coupled with block 34. Mounting assemblies 68 and 70 have first and second brackets 72 and first and second clips 74. A light source 76 is coupled with mounting block 34 by inserting light source 76 downward and at an angle through first clip 74 and into and through angled passage 64a such that the tip of light source 76 extends into recessed cavity 62. Light detector 78 is similarly coupled with mounting block 34 by inserting detector 78 downward and at an angle through second clip 74 and into and through angled passage 64b such that the tip of light detector 78 extends into recessed cavity 62. It will be understood by one skilled in the art that light source 76 and light detector 78 are disposed at angles such that light emitted from light source 76 will pass downward through window 54, reflect from soil sample 88, pass upward through window 54, and impinge on light detector 78.

It will also be understood by one skilled in the art that many light source and light detector configurations may be used with the soil sensor 10 of the present invention. Detectors are available that provide a single reading within a given band of wavelengths, while others are available that provide a simultaneous reading for each of several different wavelengths. The soil sensor 10 of the present invention provides a platform for the particular source and detector selected for a specific application, measurement, or soil type.

As best seen in FIGS. 2, 4 and 5, shank assembly 30, window plate assembly 32, and mounting block 34 are coupled with each other to present a structural platform 36 on which light source 76, light detector 78, window 56, and other components are carried. Mounting block 34 is coupled with window plate assembly 32 as described above. Shank assembly 30 is coupled with window plate assembly by inserting window plate assembly 32 into the area defined by generally U-shaped or V-shaped shank plate 40. Mounting holes 46 are aligned with bolt holes 52, and first and second beveled edges 45 and 58 are positioned in intimate contact with each other. Bolts 84 are then inserted into and through mounting holes 46 and bolt holes 52, thereby rigidly coupling shank assembly 30 with window plate assembly 32 and forming a substantially rigid structural platform 36. As best seen in FIG. 2, the bottom surfaces of shank tip 44, window plate 50, and window 56 present a substantially smooth, continuous, planar surface when shank assembly 30 is coupled with window plate assembly 32.

In operation, soil sensor 10 is coupled with vehicle 12, as depicted in FIG. 1. The operator driving vehicle 12 manipulates hydraulic piston 18 and mechanical linkage 20 to embed the shank tip 44 and window plate 50 into the ground, preferably such that the bottom surfaces of shank tip 44, window plate 50, and window 56 are at a depth of 3 to 6 inches below the surface 16 of the ground. It will be understood that sensor 10 may be used at other depths, as soil and ground conditions dictate. As vehicle 12 moves across the surface 16 of ground such as a farm field, the soil sensor 10 travels behind and in the path of vehicle 12, and shank tip 44 and the leading edge 42 of shank plate 40 form a furrow 86 in the ground, thereby exposing a soil sample 88 in the substantially smooth, horizontal plane formed in the bottom of the furrow 86.

As the bottom surfaces of shank tip 44, window plate 50, and window 56 move along the furrow 86 and slide over the exposed soil samples 88, the bottom surface of window 56 is in intimate contact with soil sample 88. There is no air space or gap between the bottom surface of window 56 and soil sample 88 during operation of the sensor. Accordingly, window 56 is inherently self-cleaning in operation as the sensor 10 moves across the ground or field, in that window 56 is continuously scoured of soil, moisture, dust, debris, and other residue that might otherwise collect on the bottom surface of window 56 and adversely affect the measurement integrity of sensor 10 by scattering or impeding light passing through window 56. If a coulter 24 is used, as shown in FIG. 1, the coulter 24 should be positioned at a depth shallower than that of the bottom surfaces of shank tip 44, window plate 50, and window 56 so that the soil sample 88 lies in a substantially smooth, horizontal plane undisturbed by grooves or other marks made by the coulter 24.

To measure the in-situ soil characteristics of the soil samples 88 exposed within furrow 86 as the sensor 10 and vehicle 12 travel across the ground, light is first emitted from light source 76, as best seen in FIG. 3. The emitted light 90 travels downward and at an angle from source 76, through recessed cavity 62, aperture 54, and window 56, and strikes and reflects off soil sample 88. The reflected light 92 then travels upwards and at an angle through window 56, aperture 54, and recessed cavity 62, and is detected by light detector 78.

In the embodiment shown in FIG. 3, light source 76 and light detector 78 are mounted directly above and adjacent to mounting plate 34 and window 56. In this configuration, electrical cables 94 connect light source 76 and light detector 78 to a power source, signal conditioner 96 (as seen in FIG. 1), computer, data logger, and/or global positioning device mounted remotely above soil sensor 10 and near vehicle 12. Alternatively, fiber optic cables or other means could be used to transmit emitted light 90 from a remotely mounted light source 76 and reflected light 92 to a remotely mounted light detector 78 and signal conditioner 96. Remote mounting of the light source 76 and light detector 78 above the soil sensor 10 and away from dirt, dust, and moisture would reduce damage to and deterioration of these components.

It will be seen from the foregoing that this invention is one well adapted to attain the ends and objects set forth above, and to attain other advantages which are obvious and inherent in the device. It will be understood that certain features and subcombinations are of utility and may be employed without reference to other features and subcombinations. This is contemplated by and within the scope of the claims. It will be appreciated by persons skilled in the art that the present invention is not limited to what has been particularly shown and described hereinabove. Rather, all matter shown in the accompanying drawings or described hereinabove is to be interpreted as illustrative and not limiting.

I claim:

1. An optical soil sensor for mobilized measurement of in-situ soil characteristics, comprising:
a shank assembly, said shank assembly adapted to be coupled with a vehicle, said shank assembly forming a furrow in the soil as said vehicle moves across the surface of the ground, said shank assembly thereby exposing a soil sample within said furrow and beneath said surface of said ground;
a window plate assembly coupled with said shank assembly, said plate assembly defining an aperture therein, said plate assembly adapted to travel behind said shank assembly and within said furrow and to be in intimate contact with said soil sample as said vehicle moves across said surface of said ground;
a window disposed within said aperture and coupled with said window plate assembly, said window adapted to travel behind said shank assembly and within said furrow and to be in intimate contact with said soil sample as said vehicle moves across said surface of said ground;
a light source, said source disposed above said window and adapted to emit light downward and through said window onto said soil sample;
a light detector, said detector disposed above said window and adapted to detect said light reflected upward from said soil sample and through said window.

2. The soil sensor of claim 1, wherein said window is formed of a synthetic sapphire material.

3. The soil sensor of claim 1, wherein said shank assembly exposes said soil sample at a depth of 3 to 6 inches beneath said surface of said ground.

4. The soil sensor of claim 1, further comprising a coulter, said coulter adapted to be coupled with said vehicle ahead of said shank assembly and to cut debris in the path of said shank assembly.

5. The soil sensor of claim 1, further comprising first and second fiber optic cables, said light source and said light detector disposed above said shank assembly, said first cable having a first end coupled with said source and a second end coupled with said window plate assembly, said source adapted to emit said light downward through said first cable and through said window onto said soil sample, said second cable having a first end coupled with said detector and a second end coupled with said window plate assembly, said detector adapted to detect said light reflected upward from said soil sample through said window and said second cable.
